(19) United States
(12) Patent Application Publication
(10) Pub. No.: US 2024/0059048 A1
(43) Pub. Date: Feb. 22, 2024

(54) METHOD FOR OBTAINING A LAMINATED CURVED GLAZING

(71) Applicant: SAINT-GOBAIN GLASS FRANCE, COURBEVOIE (FR)

(72) Inventors: Florian FLAMARY-MESPOULIE, COMPIEGNE (FR); Juliette JAMART, COMPIEGNE (FR)

(21) Appl. No.: 18/261,202

(22) PCT Filed: Jan. 11, 2022
(86) PCT No.: PCT/FR2022/050054

§ 371 Date: Jul. 12, 2023

(30) Foreign Application Priority Data
Jan. 13, 2021 (FR) 2100275
Jan. 15, 2021 (FR) 2100402
Feb. 12, 2021 (FR) 2101384

(51) Int. Cl. B32B 17/10; B32B 17/06; B32B 38/00

(52) U.S. Cl. CPC B32B 17/10036; B32B 17/061; B32B 17/10889; B32B 17/10981; B32B 17/10339; B32B 38/0036; B32B 2307/41; B32B 2307/7376; B32B 2307/202; B32B 2605/006; B32B 2250/03; B32B 2255/20; B32B 2264/1024; B32B 2264/1021; B32B 2264/303

(57) ABSTRACT

A method for obtaining a laminated curved glazing, includes a. providing a first glass sheet, covered on at least part of one of its faces with a stack of thin layers, b. depositing, on a part of a surface of the stack of thin layers, a layer of enamel, the deposition being carried out by screen-printing an enamel composition including refractory particles having a diameter of at least 20 μm in a proportion by volume of at least 0.5%, but no particles having a diameter greater than 80 μm, c. bending the first glass sheet, the stack of thin layers located under the enamel layer being completely dissolved by the enamel layer at least at the end of the bending, and then d. laminating the first glass sheet with an additional glass sheet with an lamination interlayer, so that the enamel layer faces the interlayer.

The invention relates to the field of laminated curved glazings for motor vehicles, e.g. roofs or windscreens, comprising a glass sheet coated with a stack of thin layers and an enamel layer.

Laminated glazings are glazings in which two glass sheets are adhesively bonded by means of a lamination interlayer. The latter makes it possible in particular to retain shards of glass in the event of breakage, but also provides other functions, in particular in terms of resistance to breaking and entering or improving acoustic properties.

These glazings often comprise coatings of various types, intended to confer different properties.

Enamel layers, generally black and opaque, are often deposited on part of the glazing, usually in the form of a peripheral strip intended to hide, and protect from ultraviolet radiation, the polymer seals used for attaching and positioning the glazing on the window opening of the vehicle body. Enameled zones also hide the zones for attaching the interior rear-view mirror and various connectors and sensors.

In a laminated glazing, these layers of enamel are generally arranged on face 2, with the faces traditionally being numbered starting from the face intended to be positioned on the outside of the vehicle. Face 2 is therefore a face which is in contact with the lamination interlayer. The aesthetic appearance of the enamel layer, viewed from the outside of the vehicle, holds particular importance for car manufacturers. Enamel is generally obtained by firing a composition comprising a glass frit and pigments at above 500° C. A glass frit is composed of fine particles of glass with a low melting point which, under the effect of a firing heat treatment, softens and adheres to the glass sheet. This thus forms a generally opaque mineral layer with high chemical and mechanical resistance, which adheres perfectly to the glass, holding the pigment particles. The firing step is generally carried out simultaneously with the bending of the glass sheet.

In the context of manufacturing laminated glazing, the two glass sheets of the glazing are often curved together, with the glass sheet intended to be positioned on the inside of the vehicle generally being arranged above the other glass sheet, which carries the enamel. In other processes, each glass sheet is curved separately. In all cases, it is necessary that the enamel has non-stick properties in order to prevent any bonding between the two glass sheets or between the glass sheet and the bending tools during bending. To this end, enamels containing bismuth are usually employed, i.e. enamels obtained from glass frits containing bismuth oxide.

Coatings, generally in the form of stacks of thin layers, can also be present on one of the glass sheets of the laminated glazing. These may particularly be electrically conductive layers, which can provide two types of functions. Firstly, when current supplies are provided, electrically conductive layers can dissipate heat by the Joule effect. These are then heating layers, of use for example for defrosting or defogging. Secondly, due to their reflection of infrared radiation, these layers have solar control or low-emissivity properties. The layers are thus valued for the improvement in thermal comfort or for the energy savings they provide, by reducing the consumption intended for heating or air conditioning. These stacks of layers are generally arranged on face 3 of the laminated glazing, therefore also in contact with the lamination interlayer.

Nevertheless, in some cases that will be described in detail hereinafter, it may be beneficial to have the enamel layer and the stack of thin layers on the same glass sheet, and therefore on the same face of the glass sheet in question, in order for these coatings to be protected inside the laminated glazing.

However, it has been observed that, when a glass sheet coated with a stack of thin layers required provision with an enamel layer, unwanted interactions may have occurred between the stack and the enamel during the bending, leading particularly to a degradation of the aesthetic appearance of the enamel. It has particularly been observed, especially when the stack contains at least one nitride layer and the enamel contains bismuth, that bubbles were formed within the enamel, close to the interface between the latter and the stack, causing a significant lowering of the adhesion of the enamel, altering the optical appearance thereof (in particular the color on the glass side, i.e. on the side opposite the enamel) and reducing the chemical resistance thereof, in particular to acids.

Several solutions to this problem have been proposed.

It is possible to remove beforehand the stack of thin layers at the locations where the enamel layer is to be deposited, for example by means of abrasives, in order for the enamel to be deposited in direct contact with the glass sheet and to prevent any problems of adhesion between the enamel layer and the stack of thin layers. However, mechanical abrasion produces visible scratches, including on the enamel layer.

Application WO WO2014/133929, and earlier application WO0029346, propose the concept of using, for the enamel, special glass frits which, during firing or pre-firing, are capable of dissolving the stack of thin layers to become directly attached to the glass. However, such enamels do not have good non-stick properties, causing the two glass sheets to bond together during bending.

The application WO 2019/106264 proposes modifying the stack of thin layers by adding a layer of oxide between the stack and the enamel comprising bismuth. However, it is not always possible to make such a change.

The aim of the invention is to overcome these problems.

To this end, the object of the invention is a method for obtaining a laminated curved glazing, in particular for a windscreen or roof of a motor vehicle, comprising the following successive steps:
a. providing a first glass sheet, covered on at least part of one of its surfaces with a stack of thin layers,
b. a step of depositing, on a part of the surface of the stack of thin layers, a layer of enamel, the deposition being carried out by screen-printing an enamel composition comprising refractory particles having a diameter of at least 20 μm in a proportion by volume of at least 0.5%, but no particles having a diameter greater than 80 μm,
c. a step of bending the first glass sheet, the stack of thin layers under the enamel layer being completely dissolved by said enamel layer at least at the end of this step, and then
d. a step of laminating said first glass sheet with an additional glass sheet by means of a lamination interlayer, so that the enamel layer faces said interlayer.

The invention also has as its object a laminated curved glazing, in particular for a windscreen or roof of a motor vehicle, obtained or capable of being obtained by this method. This glazing comprises a first glass sheet covered on at least part of one of its faces with a stack of thin layers coated on part of its surface with an enamel layer comprising refractory particles having a diameter of at least 20 μm in a proportion by volume of at least 0.5%, said first glass sheet being laminated with a further glass sheet by means of a lamination interlayer, said enamel layer facing said lamination interlayer.

The invention also relates to an enamel composition comprising a zinc bismuth borosilicate glass frit, at least one pigment, and at least 0.5% by volume of black refractory particles having a diameter of at least 20 μm.

The dissolution of the thin layer stack by the enamel prevents the above-mentioned interactions. The components of the stack are dissolved in the enamel layer, which is in direct contact with the glass sheet at least after the bending step (step d). The use of refractory particles avoids any bonding between the two glass sheets during bending. As shown in the following text, the choice of particle size ensures a homogeneous deposition of the particles and thus an absence of bonding.

In the present text, the stack of thin layers and the enamel layer are collectively called “the coatings”.

### Step a

The first glass sheet may be flat or curved. The first glass sheet is generally flat during the deposition of the stack of thin layers and then the enamel layer, and is then curved during step d. The first glass sheet is therefore curved in the laminated curved glazing according to the invention.

The glass of the first glass sheet is typically a soda-lime-silica glass, but other glasses, for example borosilicates or aluminosilicates, can also be used. The first glass sheet is preferably obtained by the float method, i.e. by a method consisting of pouring molten glass onto a bath of molten tin.

The first glass sheet may be made of clear glass or tinted glass, preferably of tinted glass, e.g. green, gray or blue. To this end, the chemical composition of the first glass sheet advantageously comprises iron oxide, in a content by weight ranging from 0.5 to 2%. It may also comprise other coloring agents, such as cobalt oxide, chromium oxide, nickel oxide, erbium oxide or else selenium.

The first glass sheet preferably has a thickness within a range extending from 0.7 to 19 mm, particularly from 1 to 10 mm, in particular from 2 to 6 mm, or even from 2 to 4 mm.

The lateral dimensions of the first glass sheet (and the additional glass sheet) should be adapted based on those of the laminated glazing with which it is intended to be integrated. The first glass sheet (and/or the additional glass sheet) preferably has a surface area of at least 1 m².

The first glass sheet is preferably coated with the stack of thin layers over at least 70%, particularly over at least 90%, or even over the whole of the surface of the face of the glass sheet. Indeed, some zones may not be coated in order particularly to fit communicating windows that allow waves to pass.

The stack is preferably coated with the enamel layer over 2 to 25%, particularly 3 to 20%, or even 5 to 15% of the surface thereof. The enamel layer preferably comprises a peripheral strip, i.e. a self-contained strip which, at any point of the periphery of the first glass sheet, extends inwardly towards the first glass sheet over a certain width, which generally may vary, typically between 1 and 20 cm.

The stack of thin layers is preferably in contact with the glass sheet. When being deposited, the enamel layer is preferably in contact with the stack of thin layers.

In the present text, “contact” is intended to mean physical contact. The expression “based on” is preferably intended to mean the fact that the layer in question comprises at least 50% by weight of the material in question, particularly 60%, or even 70% and even 80% or 90%. The layer may even substantially consist of, or consist of, this material. “Substantially consist of” should be understood to mean that the layer may comprise impurities which have no influence on its properties. The terms “oxide” or “nitride” do not necessarily mean that the oxides or nitrides are stoichiometric. Indeed, they may be substoichiometric, superstoichiometric or stoichiometric.

The stack preferably comprises at least one layer based on a nitride. The nitride is particularly a nitride of at least one element selected from aluminum, silicon, zirconium, titanium. It may comprise a nitride of at least two or three of these elements, for example a silicon zirconium nitride or a silicon aluminum nitride. The layer based on a nitride is preferably a layer based on silicon nitride, more particularly a layer consisting substantially of a silicon nitride. When the layer of silicon nitride is deposited by cathode sputtering, it generally contains aluminum because it is common practice to dope silicon targets with aluminum in order to accelerate the deposition rates.

The layer based on a nitride preferably has a physical thickness in a range extending from 2 to 100 nm, particularly from 5 to 80 nm.

The layers based on nitride are commonly used in a large number of stacks of thin layers since they have advantageous blocking properties, in that they prevent the oxidation of other layers present in the stack, particularly functional layers which will be described below.

The stack preferably comprises at least one functional layer, particularly an electrically conductive functional layer. The functional layer is preferably included between two thin dielectric layers, at least one of which is a layer based on nitride. Other possible dielectric layers are for example layers of oxides or oxynitrides.

At least one electrically conductive functional layer is advantageously selected from:
metal layers, particularly silver, niobium, or gold layers, and
layers of a transparent conductive oxide, particularly selected from indium tin oxide, doped tin oxides (for example doped with fluorine or antimony), doped zinc oxides (for example doped with aluminum or gallium).

These layers are particularly valued for their low emissivity, which gives the glazings excellent thermal insulation properties. In glazings equipping land vehicles, particularly motor vehicles, rail vehicles, or else aircraft or marine vessels, low-emissivity glazings make it possible, in hot weather, to outwardly reflect part of the solar radiation, and therefore to limit the heating of the passenger compartment of said vehicles, and where appropriate to reduce air-conditioning costs. Conversely, in cold weather, these glazings make it possible to retain the heat within the passenger compartment, and consequently to reduce the heating energy required. The same applies in the case of glazings equipping buildings.

According to a preferred embodiment, the stack of thin layers comprises at least one layer of silver, particularly one, two, three, or even four layers of silver. The physical thickness of the layer of silver or, where appropriate, the sum of the thickness of the layers of silver, is preferably between 2 and 50 nm, particularly between 3 and 40 nm.

According to another preferred embodiment, the stack of thin layers comprises at least one layer of indium tin oxide. The physical thickness thereof is preferably between 30 and 200 nm, in particular between 40 and 150 nm.

In order to protect the or each electrically conductive thin layer (whether metal or based on transparent conductive oxide) during the bending step, each of these layers is preferably surrounded by at least two dielectric layers. The dielectric layers are preferably based on oxide, nitride and/or oxynitride of at least one element selected from silicon, aluminum, titanium, zinc, zirconium, and tin.

At least part of the stack of thin layers can be deposited by various known techniques, for example chemical vapor deposition (CVD), or by cathode sputtering, particularly magnetic-field-assisted (magnetron method).

The stack of thin layers is preferably deposited by cathode sputtering, particularly magnetron sputtering. In this method, a plasma is created in a high vacuum close to a target comprising the chemical elements to be deposited.

By bombarding the target, the active species of the plasma tear off said elements, which are deposited on the glass sheet, forming the desired thin layer. This method is called a “reactive” method when the layer is made of a material resulting from a chemical reaction between the elements torn off from the target and the gas contained in the plasma. The major advantage of this method lies in the possibility of depositing a very complex stack of layers on the same line by making the glass sheet run in succession beneath various targets, generally in the same device.

The abovementioned examples have properties of electrical conduction and infrared reflection which are of use for providing a heating function (defrosting, defogging) and/or a thermal insulation function.

When the stack of thin layers is intended to provide a heating function, supplies of current must be provided. This may particularly be strips of silver paste deposited by screen printing on the stack of thin layers, at two opposite edges of the glass sheet.

### Step b

In the present text, “enamel composition” is used to describe the liquid composition which is used, during step b, to deposit a wet enamel layer on the glass sheet. The term “enamel layer” is used to describe the layer at each stage of the method, both the wet layer (before pre-firing, if necessary before drying) and the final layer (after firing).

In step b, the enamel layer is preferably deposited from an enamel composition comprising at least one pigment, at least one glass frit, and refractory particles. The enamel composition, like the enamel layer, preferably does not comprise lead oxide.

The enamel composition generally further comprises an organic medium, intended to facilitate the application of the composition on the substrate and also the temporary adhesion thereof to same, and which is eliminated during the pre-firing or firing of the enamel. The medium typically comprises solvents, diluents, oils and/or resins.

The glass frit is able to dissolve the underlying layer stack. Preferably the glass frit is based on bismuth zinc borosilicate. In order to make it more “aggressive” towards the stacking of layers, the bismuth and/or boron contents are preferably higher than those of the glass frits usually used.

The pigments preferably comprise one or more oxides selected from oxides of chromium, copper, iron, manganese, cobalt, and nickel. These may be, by way of example, copper and/or iron chromates.

“Refractory particles” refers to particles whose morphology is not significantly affected during the bending. These particles must have a melting or softening temperature well above the temperatures experienced during bending, and must not be dissolved by the frit. The refractory particles are based on metal oxides or metals. The metal oxides are in particular simple oxides, such as aluminium oxide, titanium oxide or zirconium oxide, or complex oxides such as high-melting glass frits or inorganic pigments (the latter are in particular called “complex inorganic colour pigments” or CICP), especially black inorganic pigments.

It was observed that the enamel composition must include a sufficient proportion of “large” refractory particles (so the size, also called diameter, is at least 20 μm) in order to prevent the glass sheets from bonding together during bending, or the glass sheet from bonding to the bending tools. Due to their size, the large refractory particles create a morphology during bending in which the particles form peaks, with the molten or softened glass frit collecting in the valleys. This size of 20 μm and more is much larger than that of the glass frit and the pigments conventionally used.

The volume proportion of refractory particles with a size (or diameter) of 20 μm and above is preferably determined by laser diffraction particle sizing. This proportion is at least 0.5% and preferably at least 1%, in particular at least 2% and even at least 3%.

Preferably, the enamel composition contains refractory particles with a diameter of at least 30 μm, in particular at least 40 μm, and even at least 50 μm, in the above-mentioned volume proportions.

Another way to characterize the enamel composition, and to easily detect the presence of large particles, is to measure the fineness of the particles with a Hegman gage (or fineness of grind gage). According to this method, the fineness of the enamel composition, measured with a Hegman gage, is between 20 and 80 μm, in particular between 40 and 60 μm.

The enamel composition must not contain particles (refractory or not) with a diameter greater than 80 μm, in order to allow for screen printing. The presence of such particles can be determined by laser diffraction particle sizing or with a Hegman gage.

The refractory particles are preferably zirconia-based. Zirconia-based particles are particles comprising at least 80% by weight, in particular 85% by weight, of zirconium oxide (ZrO₂). The zirconia is preferably stabilized, in particular with yttrium. It may also contain sintering aid additives, in particular selected from Al₂O₃, TiO₂, ZnO, SiO₂ and mixtures thereof.

Preferably, the zirconia-based particles have a chemical composition comprising, in particular consisting of, the following constituents in the following ranges of weight contents:
ZrO₂: 83-97%
Y₂O₃: 2-8%
Al₂O₃: 0-3%
black pigments: 0-6%, particularly 1-6%.

The zirconia-based particles are preferably calcined, in particular at a temperature between 1,100 and 1,500° C.

The zirconia-based particles preferably have a volume particle size distribution, determined by laser particle sizing, such that the D10 is at least 20 μm, in particular between 30 and 45 μm, the D50 is between 40 and 52 μm and the D90 is at most 65 μm, in particular between 55 and 65 μm.

The refractory particles, especially those based on zirconia, are preferably black. In particular, the lightness L* in reflection is preferably less than 3, and even more preferably less than 1. The colorimetric coordinates a* and b* are preferably each less than 0.5, in particular 0.1. The colorimetric parameters are determined in accordance with ISO 7724)(D65-10°. For this purpose, the particles, in particular those based on zirconia, may contain black pigments, typically in a content of between 1 and 6% by weight.

The average sphericity of the refractory particles, in particular the black refractory particles, is preferably greater than 0.60, in particular 0.70, or even 0.80 and even greater than 0.85. The sphericity of a particle is the ratio of the smallest Feret diameter to the largest Feret diameter. The average roundness of the refractory particles is preferably greater than 0.6, in particular 0.7 and even 0.8 or 0.9. The average sphericity (or roundness) is the arithmetic mean of the sphericity (or roundness) of 50 to 200 particles. The roundness corresponds to 4.A/π.Lf², Lf being the largest Feret diameter and A the projected area of a particle. These different parameters, in particular the Feret diameters, are measured by dynamic image analysis, for example using a Camsizer XT particle analyzer marketed by Horiba.

It has been observed that the use of black particles and/or spherical particles, without too many asperities, improves the aesthetics of the enamel after firing, in particular by reducing the haze visible in reflection from face 1 under strong illumination.

The enamel layer is deposited by screen printing. To this end, a screen printing screen is placed on the glass sheet, which screen comprises apertures, some of which are blocked off, then the enamel composition is deposited on the screen, then a squeegee is applied in order to force the enamel composition through the screen in the zones where the screen apertures have not been blocked off, so as to form a wet enamel layer. In order to ensure homogeneous deposition of the large refractory particles, the mesh aperture of the screen is preferably at least 40 μm, in particular at least 60 μm, or even at least 70 μm. A mesh aperture that is too small will trap the particles and prevent their homogeneous deposition, while a mesh aperture that is too large will lead to a too high enamel thickness that may weaken the glass mechanically. The mesh aperture size is preferably at most 100 μm, in particular at most 80 μm.

The thickness of the layer of wet enamel is preferably between 15 and 40 μm, in particular between 20 and 30 μm.

Step b is preferably immediately followed by a drying step, intended to remove at least part of the solvent contained in the enamel composition. Such drying is typically carried out at a temperature of between 120 and 180° C.

### Step c

Bending can be carried out using gravity, for example (the glass deforms under its own weight) or through pressing, at temperatures typically ranging from 550 to 650° C.

In a first embodiment, the two glass sheets (first glass sheet and additional glass sheet) are curved separately. In this case, it is important to avoid any bonding between the first glass sheet and the bending tools.

According to a second embodiment, the first glass sheet and the additional glass sheet are curved together, with the enamel layer facing said additional glass sheet. In this case, it is important to avoid any bonding between the two glass sheets. The glass sheets can be kept apart by placing an intercalated powder between them to ensure a gap of a few tens of micrometers, typically 20 to 50 μm. The interlayer powder is for example based on calcium and/or magnesium carbonate. During the bending, the interior glass sheet (intended to be positioned inside the passenger compartment) is normally placed above the exterior glass sheet. Thus, during the bending step, the additional glass sheet is placed above the first glass sheet.

Preferably, after step d, the enamel layer is opaque with a black hue. The lightness L* thereof, measured in reflection on the side of the glass, is preferably less than 5. As indicated above, it advantageously forms a strip at the periphery of the first glass sheet. The enamel layer is thereby capable of hiding and protecting seals, connecting elements or else sensors from ultraviolet radiation.

If the enamel layer has not already completely dissolved the thin layer stack after the pre-firing described below, this is achieved during the bending process, which completes the enamel firing.

The total dissolution of the thin film stack can be observed by electron microscopy. Electrical measurements, in particular square resistance, also allow the dissolution of the stack to be determined.

### Optional Pre-Firing Step (b1)

The method preferably comprises, between step b) and step c), a step b1) of pre-firing the enamel layer during which the thin layer stack below the enamel layer is at least partially dissolved by said enamel layer.

This step is particularly useful in the second embodiment previously described, in which the glass sheets are curved together.

The pre-firing step is preferably carried out at a temperature of between 150 and 800° C., in particular between 500 and 700° C.

Such a pre-firing allows the removal of the organic medium, or in general any organic component that may be present in the enamel layer.

During the pre-firing, the thin layer stack is at least partially dissolved by the enamel layer. Depending on the temperature used and the type of enamel or stack, the stack may even be completely dissolved by the enamel layer during the pre-firing. Alternatively, it may be only partially dissolved during pre-cooking, and is then completely dissolved during bending (step c).

### Step d

The step of lamination may be carried out by treatment in an autoclave, for example at temperatures from 110 to 160° C. and under a pressure ranging from 10 to 15 bar. Prior to the autoclave treatment, the air trapped between the glass sheets and the lamination interlayer can be eliminated by calendering or by applying negative pressure.

As stated above, the additional sheet is preferably the interior sheet of the laminated glazing, i.e. the sheet located on the concave side of the glazing, intended to be positioned inside the passenger compartment. Thus, the coatings are arranged on face 2 of the laminated glazing.

The additional glass sheet may be made of soda-lime-silica glass or else of borosilicate or aluminosilicate glass. It may be made of clear or tinted glass. Its thickness is preferably between 0.5 and 4 mm, particularly between 1 and 3 mm.

According to a preferred embodiment, the additional glass sheet has a thickness of between 0.5 and 1.2 mm. The additional glass sheet is particularly made of sodium aluminosilicate, preferably chemically reinforced. The additional glass sheet is preferably the interior sheet of the laminated glazing. The invention is particularly useful for this type of configuration for which it is difficult to arrange the stack of thin layers on face 3. The chemical reinforcement (also referred to as “ion exchange”) consists in bringing the surface of the glass into contact with a molten potassium salt (for example potassium nitrate) so as to reinforce the surface of the glass by exchanging ions of the glass (in this case sodium ions) with ions having a larger ionic radius (in this case potassium ions). This ion exchange makes it possible to form compressive stresses at the surface of the glass and over a certain thickness. Preferably, the surface stress is at least 300 MPa, particularly 400 and even 500 MPa, and at most 700 MPa, and the thickness of the zone under compression is at least 20 μm, typically between 20 and 50 μm. The stress profile can be determined in a known way using a polarizing microscope fitted with a Babinet compensator. The chemical tempering step is preferably carried out at a temperature ranging from 380 to 550° C., and for a duration ranging from 30 minutes to 3 hours. The chemical reinforcement is preferably carried out after the bending step but before the lamination step. The glazing obtained is preferably a motor vehicle windscreen, in particular a heating windscreen.

According to another preferred embodiment, the additional glass sheet carries, on the face opposite the face which is facing the lamination interlayer (preferably face 4, the additional sheet being the interior sheet), an additional stack of thin layers, particularly a low-emissivity stack, comprising a transparent conductive oxide, particularly indium tin oxide (ITO). The invention is also particularly useful for this type of configuration for which it is tricky to arrange the stacks of thin layers on both faces of the same glass sheet (face 3 and 4). In this embodiment, the lamination interlayer and/or the additional glass sheet is preferably tinted, the glass sheet carrying the coatings being able to be made of clear glass. The glazing obtained is preferably a motor vehicle roof.

As an example of the latter preferred embodiment, mention may be made of a laminated curved roof comprising, from the outside of the vehicle, a clear glass sheet coated on face 2 with a stack of thin layers comprising at least one silver layer then an enamel layer, a lamination interlayer made of tinted PVB, and an additional glass sheet made of tinted glass, carrying, on face 4, a low-emissivity stack of thin layers, particularly based on ITO.

The lamination interlayer preferably comprises at least one sheet of polyvinyl acetal, particularly polyvinyl butyral (PVB).

The lamination interlayer can be tinted or untinted in order, if necessary, to regulate the optical or thermal properties of the glazing.

The lamination interlayer may advantageously have acoustic absorption properties in order to absorb airborne or structure-borne sounds. To this end, it may particularly consist of three polymeric sheets, including two “external” PVB sheets surrounding an internal polymeric sheet, optionally made of PVB, with a lower hardness than that of the outer sheets.

The lamination interlayer may also have thermal insulation properties, in particular properties of infrared radiation reflection. To this end, it may comprise a coating of thin layers with low-emissivity, for example a coating comprising a thin layer of silver or a coating alternating dielectric layers with different refractive indices, deposited on an internal PET sheet surrounded by two external PVB sheets.

The thickness of the lamination interlayer is generally within a range extending from 0.3 to 1.5 mm, particularly from 0.5 to 1 mm. The lamination interlayer can have a smaller thickness on an edge of the glazing than at the center of the glazing in order to prevent the formation of a double image in the case of using a head-up display (HUD).

### EXAMPLES

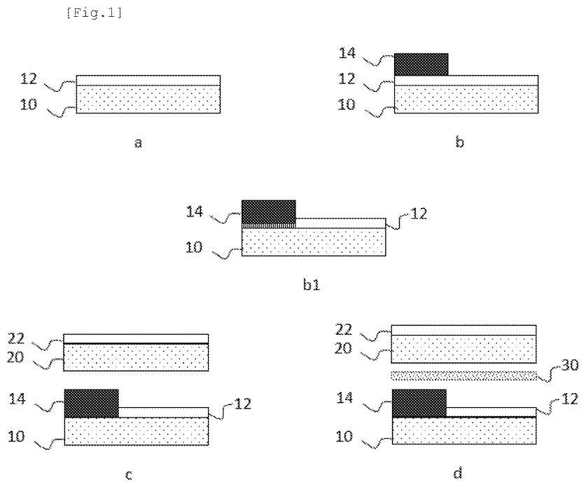

The example embodiments which follow illustrate the invention in a non-limiting manner, in connection with FIG. 1.

FIG. 1 schematically illustrates an embodiment of the method according to the invention. It shows a schematic cross-section of a portion of the glass sheets and the elements deposited on the glass sheets near their periphery. The various elements are obviously not represented to scale, so that they can be visualized.

The first glass sheet 10 coated with the thin film stack 12 is provided in step a, and then part of the stack 12 is coated with an enamel layer 14, in particular by screen printing (step b).

The assembly then undergoes a pre-firing (step b1), which in the illustrated case leads to a partial dissolution of the stack 12 by the enamel 14.

An additional glass sheet 20, herein provided with a further thin layer stack 22, is then placed on the first glass sheet 10, the assembly then being curved (step c). As the view shown is only from the end of the glass sheet, the curvature is not shown here. The diagram illustrates that, after bending, the enamel 14 has completely dissolved the underlying thin layer stack 12.

In step d, the first glass sheet 10 coated with the thin film stack 12 and the enamel layer 14 and the additional glass sheet 20 coated with the additional stack 22 are joined together with the aid of the laminating interlayer 30. The diagram shows each of the elements separately, in exploded view.

The method used in the examples corresponds to the embodiment shown in FIG. 1.

Glass sheets 2.1 mm thick, coated beforehand by cathode sputtering of a stack of thin layers comprising three silver layers protected by zinc oxide layers, silicon nitride layers and NiCr blockers, were coated by screen printing with enamel layers with a wet thickness of 25 μm.

The enamel composition included large refractory oxide particles larger than 20 μm.

Two types of particles were used: particles marked A in the table below, which are white and irregularly shaped, and particles marked B in the table below, which are zirconia-based, black, and more rounded in shape than the A particles. Particles B were black zirconia granules marketed under the name ColorYZe G Black by Saint-Gobain Zirpro, calcined at a temperature of 1300° C.

Particles B had the following chemical composition (by weight): ZrO₂: 89.6%, Y₂O₃: 5.26%, Al₂O₃: 1.05%, black pigments: 4.1%. The particle size distribution by volume was as follows: D10=40 μm, D50=49 μm, D90=60 μm.

Table 1 below shows the proportion by volume of these particles for each test, noted as “% vol”.

The enamel layer was deposited using a screen with a mesh aperture size of 71 μm (screen 1) or 49 μm (screen 2), depending on the example.

The enamel was then dried (150° C., 1 to 2 minutes) and pre-fired at approximately 650° C.-680° C.

After pairing with an additional glass sheet of soda-lime glass with a stack comprising an ITO layer on face 4, the assembly was curved at over 600° C. for 350 to 500 seconds.

After firing, the appearance, more particularly the black color viewed from face 1, was evaluated by measuring the lightness L* in reflection (illuminant D65, reference observer 10°). A value less than or equal to 6.0, preferably less than 5.0, is considered acceptable. The haze (from face 1 of the glazing) and bonding were assessed qualitatively by visual observation.

For bonding, a scale of 0 to 5 was used, where a score of 0 means no defects, a score of 1 means limited enamel transfer in the corners, a score of 2 means enamel transfer in the corners and sides, a score of 3 means bonding in the corners, a score of 4 means bonding in the corners and sides, and a score of 5 means total bonding. A score higher than 3 is not acceptable.

TABLE 1

| | Part. | % vol | Screen | Thickness (μm) | L* | Haze | Bonding |
|---|---|---|---|---|---|---|---|
| C0 | — | 0 | 1 | 14.0 | 5.1 | − | 5 |
| C1 | A | <0.5% | 1 | 14.0 | 5.8 | − | 4 |
| C2 | A* | | 1 | N/A | | | |
| 1 | A | 2% | 1 | 14.0 | 4.6 | + | 1 |
| 2 | A | 2% | 2 | 11.9 | 5.0 | + | 2 |
| 3 | B | 3% | 1 | 14.0 | 4.5 | − | 0 |
| 4 | B | 3% | 1 | 14.0 | 4.8 | − | 0 |

The comparative example C0 shows that the absence of large refractory particles results in complete bonding. In the case of comparative example C1, the addition of refractory particles, but in too small quantities, does not sufficiently reduce bonding. In the case of example C2, the presence of refractory particles larger than 80 μm did not allow the enamel layer to be deposited by screen printing.

The addition of the refractory particles A (examples 1 and 2) reduces this bonding, especially as the proportion of coarse particles and the mesh aperture size of the screen printing screen are large, but generate a slight haze.

In the case of examples 3 and 4, the B particles, which are black and more spherical than the A particles, made it possible to achieve a lack of bonding while reducing the haze.

1. A method for obtaining a laminated curved glazing, comprising the following successive steps:
a. providing a first glass sheet, covered on at least part of one of its faces with a stack of thin layers,
b. depositing, on a part of a surface of the stack of thin layers, a layer of enamel, the deposition being carried out by screen-printing an enamel composition comprising refractory particles having a diameter of at least 20 μm in a proportion by volume of at least 0.5%, but no particles having a diameter greater than 80 μm,
c. bending the first glass sheet, the stack of thin layers located under the enamel layer being completely dissolved by said enamel layer at least at the end of the step of bending, and then
d. laminating said first glass sheet with an additional glass sheet with an lamination interlayer, so that the enamel layer faces said interlayer.

2. The method according to claim 1, wherein the stack of thin layers comprises at least one functional layer.

3. The method according to claim 2, wherein the electrically conductive functional layer is a metal layers and a layers of a transparent conductive oxide.

4. The method according to claim 1, wherein after step d, the enamel layer is opaque, has a black hue, and forms a strip at the periphery of the first glass sheet.

5. The method according to claim 1, wherein the refractory particles are based on metal oxides or metals.

6. The method according to claim 5, wherein the metal oxides are simple oxides or complex oxides.

7. The method according to claim 6, wherein the refractory particles are zirconia-based.

8. The method according to claim 1, wherein the refractory particles are black.

9. The method according to claim 1, wherein an average sphericity of the refractory particles is greater than 0.60.

10. The method according to claim 1, wherein the deposition of the enamel layer is carried out by screen printing using a screen printing screen having an aperture size of at least 40 μm.

11. The method according to claim 1, wherein:
the method comprises between step b) and step c) a step b1) of pre-firing the enamel layer during which the thin layer stack located under the enamel layer is at least partially dissolved by said enamel layer, and
in step c) the first glass sheet and the additional glass sheet are curved together with the enamel layer facing said additional glass sheet.

12. The method according to claim 1, wherein the additional glass sheet has a thickness of between 0.5 and 1.2 mm.

13. The method according to claim 1, wherein the additional glass sheet carries, on the face opposite the face facing the lamination interlayer, an additional stack of thin layers.

14. A laminated curved glazing, in particular for a windscreen or roof of a motor vehicle, obtainable by the method of claim 1, comprising a first glass sheet coated on at least part of one of its faces with a stack of thin layers, said first glass sheet being coated on part of its surface with an enamel layer comprising refractory particles having a diameter of at least 20 μm in a proportion by volume of at least 0.5%, said first glass sheet being laminated with an additional glass sheet with an lamination interlayer, said enamel layer facing said lamination interlayer.

15. An enamel composition for carrying out the method according to claim 8, comprising a zinc bismuth borosilicate-based glass frit, at least one pigment and at least 0.5% by volume of black refractory particles having a diameter of at least 20 μm, but not comprising particles having a diameter greater than 80 μm.

16. The method according to claim 1, wherein the laminated curved glazing is a windscreen or roof of a motor vehicle.

17. The method according to claim 2, wherein the at least one functional layer is an electrically conductive functional layer.

18. The method according to 3, wherein the metal layer is a silver or niobium layer and the layer of a transparent conductive oxide is a layer of indium tin oxide, doped tin oxide, or doped zinc oxide.

19. The method according to claim 6, wherein the simple oxides are aluminum oxide, titanium oxide or zirconium oxide and the complex oxides are high-melting glass frits or inorganic pigments.

20. The method according to claim 9, wherein an average sphericity of the refractory particles is greater than 0.70.
